(19) United States
(12) Patent Application Publication
(10) Pub. No.: US 2025/0168606 A1
(43) Pub. Date: May 22, 2025

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Jinhua WU, Beijing (CN)

(21) Appl. No.: 18/872,460

(22) PCT Filed: Jun. 9, 2022
(86) PCT No.: PCT/CN2022/097966

§ 371 Date: Dec. 6, 2024

(51) Int. Cl. H04W 4/38; H04W 8/02

(52) U.S. Cl. CPC H04W 4/38; H04W 8/02

(57) ABSTRACT

An information processing method is performed by a core network device of a visited public land mobile network (VPLMN), and includes: receiving request information sent by a user equipment (UE), wherein the request information is configured to request service information of a visited sensing application function; and sending the service information of the visited sensing application function to the UE based on the request information, wherein the service information is at least configured to indicate an address of the visited sensing application function.

### CROSS REFERENCE TO RELATED APPLICATION

The present application is a U.S. National Stage of International Application No. PCT/CN2022/097966, filed on Jun. 9, 2022, the content of which is incorporated by reference herein in its entirety.

### TECHNICAL FIELD

The present disclosure relates to, but is not limited to, the field of communication technology, and in particular to an information processing method, device, communication apparatus, and storage medium.

### BACKGROUND

In cellular mobile communication technology, mobile communication networks can use an integrated communication and sensing (ICS) solution to integrate the two functions of communication and sensing, so that the communication system has both communication and sensing functions. While transmitting sensing information on the wireless channel, the physical characteristics of the surrounding environment are sensed by actively recognizing and analyzing the characteristics of the channel.

Integrated sensing and communication in cellular mobile communication systems means that the sensing capability is provided by the wireless communication system and infrastructure as used for communication, and the sensing information can be derived from RF-based and/or non-RF based sensors. ICS involves scenarios of communication assisted sensing, e.g., where 5G communication systems provide sensing services or sensing assisted communication; e.g., when sensing information related to the communication channel and the environment is used to improve the communication service of the 5G system itself; e.g., the sensing information can be used to assist radio resource management, interference mitigation, beam management, mobility, etc.

### SUMMARY

According to a first aspect of the present disclosure, there is provided an information processing method, performed by a core network device of a visited public land mobile network (VPLMN), including:

receiving request information sent by a user equipment UE, where the request information is configured to request service information of a visited sensing application function (VSAF);

sending the service information of the visited sensing application function to the UE based on the request information, where the service information is at least configured to indicate an address of the visited sensing application function.

According to a second aspect of the present disclosure, there is provided an information processing method, performed by a user equipment UE, including:
sending request information to a core network device of a visited public land mobile network VPLMN, where the request information is configured to request service information of a visited sensing application function; and
receiving the service information of the visited sensing application function sent by the core network device based on the request information, where the service information is at least configured to indicate an address of the visited sensing application function.

According to a third aspect of the present disclosure, there is provided an information processing device, including:
a transceiver module configured to receive request information sent by a user equipment UE, where the request information is configured to request service information of a visited sensing application function;
the transceiver module is further configured to send the service information of the visited sensing application function to the UE based on the request information, where the service information is at least configured to indicate an address of the visited sensing application function.

According to a fourth aspect of the present disclosure, there is provided an information processing device, including:
a transceiver module configured to send request information to a core network device of a visited public land mobile network VPLMN, where the request information is configured to request service information of a visited sensing application function;
the transceiver module is further configured to receive the service information of the visited sensing application function sent by the core network device based on the request information, where the service information is at least configured to indicate an address of the visited sensing application function.

According to a fifth aspect of the present disclosure, there is provided a communication device, where the communication device includes:
a processor;
a memory for storing executable instructions of the processor;
where the processor is configured to implement the information processing method according to the first aspect or the second aspect when running the executable instructions.

According to a sixth aspect of the present disclosure, there is provided a computer storage medium, where the computer storage medium stores a computer executable program, and the executable program, when executed by the processor, implements the information processing method according to the first aspect or the second aspect.

It should be understood that the above general description and the detailed description below are only examples and explanatory, and cannot limit the embodiment of the present disclosure.

### BRIEF DESCRIPTION OF THE DRAWINGS

FIG. 1 is a schematic diagram of a structure of a wireless communication system according to an example embodiment.

FIG. 2 is a schematic diagram of UE roaming according to an example embodiment.

FIG. 3 is a flowchart of an information processing method according to an example embodiment.

FIG. 4 is a block diagram of a non-roaming scenario architecture according to an example embodiment.

FIG. 5 is a block diagram of a roaming scenario architecture according to an example embodiment.

FIG. 6 is a flowchart of an information processing method according to an example embodiment.

FIG. 7 is a schematic diagram of a SUPI structure according to an example embodiment.

FIG. 8 is a flowchart of an information processing method according to an example embodiment.

FIG. 9 is a flowchart of an information processing method according to an example embodiment.

FIG. 10 is a flowchart of an information processing method according to an example embodiment.

FIG. 11 is a flowchart of an information processing method according to an example embodiment.

FIG. 12 is a flowchart of an information processing method according to an example embodiment.

FIG. 13 is a flowchart of an information processing method according to an example embodiment.

FIG. 14 is a flowchart of an information processing method according to an example embodiment.

FIG. 15 is a flowchart of an information processing method according to an example embodiment.

FIG. 16 is a flowchart of an information processing method according to an example embodiment.

FIG. 17 is a block diagram of an information processing device according to an example embodiment.

FIG. 18 is a block diagram of an information processing device according to an example embodiment.

FIG. 19 is a block diagram of a UE according to an example embodiment.

FIG. 20 is a block diagram of a base station according to an example embodiment.

### DETAILED DESCRIPTION

Here, example embodiments will be described in detail, examples of which are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include the plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “upon” or “when” or “in response to determining”.

FIG. 1 shows a schematic diagram of a structure of a wireless communication system provided by an embodiment of the present disclosure. As shown in FIG. 1, the wireless communication system is a communication system based on cellular mobile communication technology, and the wireless communication system may include a number of user equipment 110 and a number of base stations 120.

The user equipment 110 may be a device that provides voice and/or data connectivity to a user. The user equipment 110 may communicate with one or more core networks via a radio access network (RAN). The user equipment 110 can be an Internet of Things UE, such as a sensor device, a mobile phone (or called “cellular” phone), and a computer with an Internet of Things UE. For example, it may be a fixed, portable, pocket-sized, handheld, computer-built-in or vehicle-mounted device, such as station (STA), subscriber unit, subscriber station, mobile station, mobile, remote station, access point, remote terminal, access terminal, user terminal, user agent, user device, or user equipment (UE). Alternatively, the user equipment 110 may also be a device of an unmanned aerial vehicle. Alternatively, the user equipment 110 may also be a vehicle-mounted device, for example, a trip computer with a wireless communication function, or a wireless communication device connected externally to the trip computer. Alternatively, the user equipment 110 may also be a roadside device, for example, a street lamp, a signal lamp or other roadside device with a wireless communication function.

The base station 120 may be a network-side device in a wireless communication system. The wireless communication system may be a 4th generation mobile communication (4G) system, also known as a long-term evolution (LTE) system; or, the wireless communication system may be a 5G system, also known as a new radio system or a 5G NR system. Alternatively, the wireless communication system may be a next generation system of the 5G system. The access network in the 5G system may be referred to as a new generation radio access network (NG-RAN).

The base station 120 may be an evolved base station (eNB) used in a 4G system. Alternatively, the base station 120 may also be a base station (gNB) using a centralized distributed architecture in a 5G system. When the base station 120 uses a centralized distributed architecture, it generally includes a central unit (CU) and at least two distributed units (DU). The central unit is provided with a protocol stack of a packet data convergence protocol (PDCP) layer, a radio link layer control protocol (RLC) layer, and a medium access control (MAC) layer. The distributed unit is provided with a physical (PHY) layer protocol stack. The specific implementation method of the base station 120 is not limited in the embodiment of the present disclosure.

A wireless connection can be established between the base station 120 and the user equipment 110 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new radio; or, the wireless air interface can also be a wireless air interface based on the next generation mobile communication network technology standard of 5G.

In some embodiments, an E2E (End to End) connection can also be established between the user equipment 110, e.g., in a scenario such as vehicle to vehicle (V2V) communication, vehicle to infrastructure (V2I) communication and vehicle to pedestrian (V2P) communication in vehicle to everything (V2X) communication.

Here, the user equipment can be considered as the terminal device of the following embodiments.

In some embodiments, the wireless communication system can further include a network management device 130.

Several base stations 120 are respectively connected to the network management device 130. The network management device 130 can be a core network device in the wireless communication system. For example, the network management device 130 can be a mobility management entity (MME) in the evolved packet core (EPC). Alternatively, the network management device may also be other core network devices, such as a Serving GateWay (SGW), a Public Data Network GateWay (PGW), a Policy and Charging Rules Function (PCRF), or a Home Subscriber Server (HSS). The embodiment of the present disclosure does not limit the implementation form of the network management device 130.

In order to facilitate the understanding of those skilled in the art, the embodiment of the present disclosure lists multiple implementations to clearly illustrate the technical solution of the embodiment of the present disclosure. Of course, those skilled in the art can understand that the multiple embodiments provided in the embodiment of the present disclosure can be executed individually, or can be executed in combination with the methods of other embodiments in the embodiments of the present disclosure, or can be executed with some methods in other related art after being executed individually or in combination with the methods of other embodiments in the embodiments of the present disclosure; the embodiment of the present disclosure does not limit this.

Mobile operators can play an important role in providing customers with integrated applications of communication and sensing based on the 5G system (5GS), including the management and control of the sensing service based on 5G, e.g., infrastructure assisted environment perception, infrastructure-based tele-operated driving, high-definition map collecting and sharing, and tele-operated driving support.

Examples of communication-assisted sensing services that 5GS can provide can include:

1. Environment Real-time monitoring: Using wireless signals to reconstruct the environment map to further improve positioning accuracy and enable environment related applications, such as realizing an array of real-time monitoring related applications including dynamic 3D map for driving assistance, pedestrian flow statistics, intrusion detection, traffic detection and etc.

2. Autonomous vehicles/UAV: Autonomous vehicles/UAV applications have some common functional requirements. For example, Autonomous vehicles/UAV shall support Detect and Avoid (DAA) to avoid obstacles. Meanwhile, Autonomous vehicles/UAV shall have the capability to monitor path information, like selecting routes, complying with traffic regulations.

3. Air pollution monitoring: The quality of the received wireless signal displays different attenuation characteristics with changes in air humidity, air particulate matter (PM) concentration, carrier frequency and etc., which can be used for weather or air quality detection.

4. Indoor Health Care and Intrusion Detection: Respiration rate estimation, breathing depth estimation, apnoea detection, elders' vital sign monitoring and indoor intrusion detection can be realized.

Sensing of wireless communication channels and environment could further improve the performance of communication systems. Some examples of sensing assisted communication scenarios can include:

5. Sensing UE's location and channel environment to narrow the beam sweeping range and shorten the beam training time.

6. Sensing UE's location, velocity, motion trajectory, and channel environment for beam prediction, and reducing the overhead of beam measurement and the delay of beam tracking.

7. Sensing UE's property and channel environment to improve the performance of channel estimation.

In the core network side, the sensing service is provided by the Sensing Application Function (SAF). The sensing service function can be deployed on a sensing server. Different sensing service functions can be deployed on the same or different sensing servers. When the UE is moving and performing different types of sensing processing, it requires access to different sensing service functions.

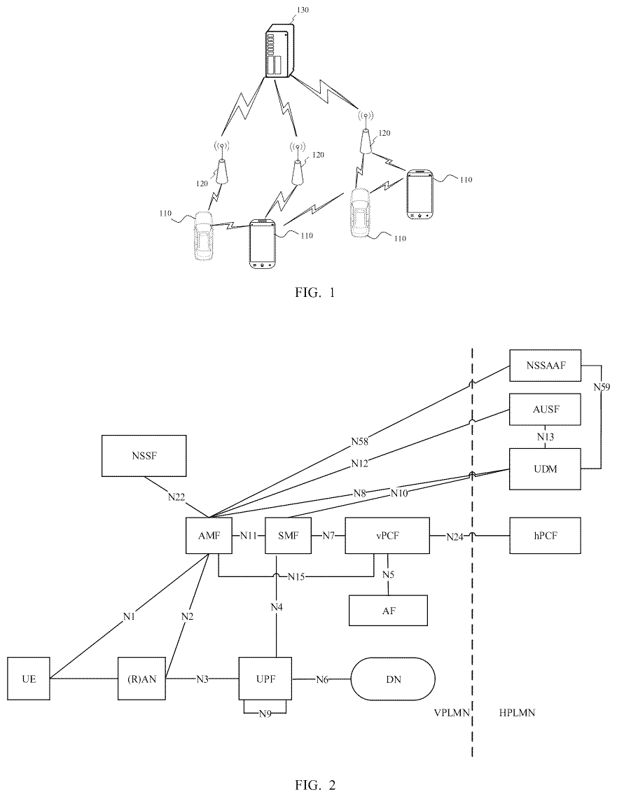

As shown in FIG. 2, during the movement of the UE, there will be a situation where the UE roams from the signal coverage of the Home Public Land Mobile Network (HPLMN) to the signal coverage of the Visited Public Land Mobile Network (VPLMN). When the UE roams into the signal coverage of the VPLMN, how to perform the sensing service is an urgent problem to be solved.

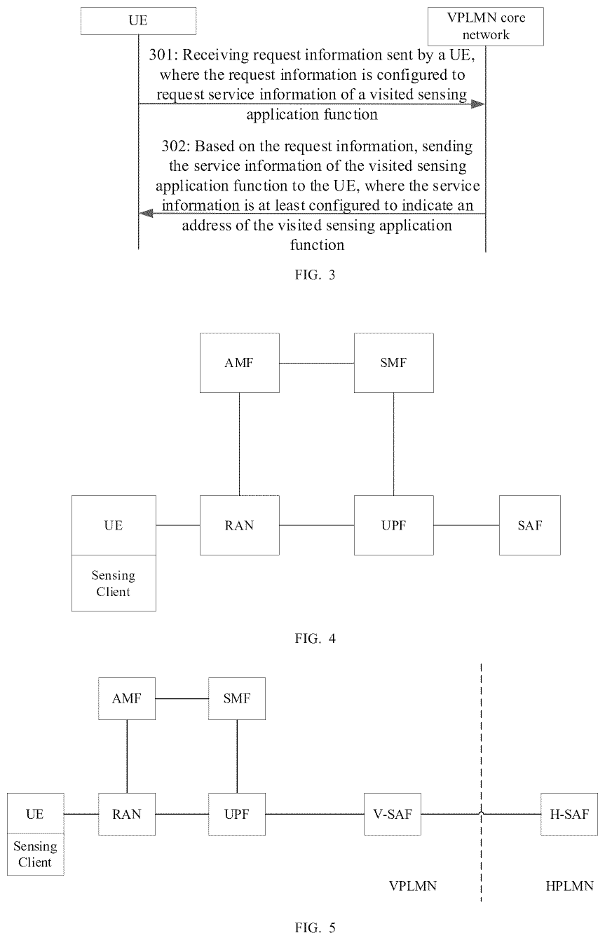

As shown in FIG. 3, the embodiment of the present disclosure provides an information processing method, which is executed by the core network of the VPLMN, including:
Step 301: receiving request information sent by a user equipment UE, where the request information is configured to request service information of a visited sensing application function;
Step 302: based on the request information, sending the service information of the visited sensing application function to the UE, where the service information is at least configured to indicate an address of the visited sensing application function.

The visited sensing application function can be configured to provide a sensing service to the UE during the UE roaming to the VPLMN. Here, the sensing service includes but is not limited to a sensing service based on a communication signal, e.g., environmental sensing based on a communication signal, etc.

In an implementation, the service information includes location information of the visited sensing application function, such as an IP address, etc. The visited sensing application function can be deployed in a sensing application server. The UE can access the visited sensing application function and/or register to the visited sensing application function based on the service information, etc. The service information further includes access information of the visited sensing application function. The access information may include information required by the UE for sensing through the visited sensing application function. The access information may include, but is not limited to, access authentication information of the visited sensing application function, type information of the visited sensing application function, etc.

As shown in FIG. 4, in a non-roaming case, the UE is in the HPLMN and performs the sensing service through the home sensing application function. As shown in FIG. 5, in a roaming case, the UE leaves the signal coverage of the HPLMN and needs to perform the sensing service through the visited sensing application function of the VPLMN.

The UE performs the sensing service through the visited sensing application function of the VPLMN and needs to obtain the service information of the visited sensing application function, such as location information, etc.

The UE may send request information to the core network of the VPLMN to request service information of the visited sensing application function. The request information may be an indicator to request the service information of the visited sensing application function from the core network. The request information may include associated information of the requested visited sensing application function to limit the requested visited sensing application function. For example, the request information may include type information of the visited sensing application function, etc., to indicate the type of the requested visited sensing application function.

In one embodiment, the request information is configured to request a data network name (DNN) associated with the visited sensing application function.

The visited sensing application function may have a specific DNN, and the UE may send a DNN associated with the visited sensing application function to the core network of the VPLMN to request service information of the visited sensing application function from the core network of the VPLMN.

In an implementation, the request information may also be implicitly indicated by the capability information of the UE. The UE may report its own sensing capability to the core network of the VPLMN. When the core network of the VPLMN determines that the UE has the sensing capability, the service information of the visited sensing application function may be sent to the UE.

In an implementation, the request information may be carried in the uplink NAS message and forwarded by the access network device to the core network device. Here, the access network device may include a base station.

In an implementation, the request information may be for a specific sensing application function. For example, the request information may include type indication information of the requested sensing application function. The request information may also be for all sensing application functions, and the request information is configured to request all sensing application functions available to the UE.

After obtaining the request information, the core network of the VPLMN may send the service information of the visited sensing application function to the UE.

In an implementation, the service information of the visited sensing application function may be determined based on the request information. The core network of the VPLMN may send the service information of the sensing application function of the specified type to the UE according to the indication of the request information. The core network of the VPLMN may send the service information of the sensing application function that the current UE can use to the UE according to the indication of the request information.

The service information of the visited sensing application function can be carried in the downlink NAS message and forwarded to the UE by the access network device. The service information of the visited sensing application function sent to the UE can be the service information of one or more visited sensing application functions.

In an implementation, the service information can be pre-stored in the core network of the VPLMN.

The service information of the visited sensing application function can be pre-stored in the core network. For example, the service information of the visited sensing application function can be pre-stored in network elements such as AMF and SMF. The core network of the VPLMN can obtain the stored service information of the visited sensing application function and/or obtain the service information of the visited sensing application function from other network elements of the core network, and send it to the UE. For example, the core network of the VPLMN can obtain the service information of the visited sensing application function from the SMF.

In this way, the UE sends the request information to the core network of the VPLMN, and the core network of the VPLMN sends the service information of the visited sensing application function to the UE in response to the request information, so that the UE obtains the service information of the visited sensing application function, which provides a basis for the UE to perform the sensing service during roaming.

In one embodiment, receiving the request information sent by the user equipment UE includes at least one of the following:
receiving, by the access and mobility management function AMF of the core network device, the request information sent by the UE;
receiving, by the session management function SMF of the core network device, the request information sent by the AMF;
sending the service information of the visited sensing application function to the UE based on the request information includes at least one of the following:
sending, by the SMF, the service information to the AMF in response to the request information;
sending, by the AMF, the service information to the UE.

Here, network elements such as AMF, SMF, PCF, and UPF, unless otherwise specified, refer to the core network elements of the VPLMN.

The UE can send request information to the AMF of the core network, and the AMF forwards the request information to the SMF.

The service information of the visited sensing application function sent by the AMF to the UE can be received from the SMF. The AMF can send the request information to the SMF, and the SMF sends the service information of the visited sensing application function to the AMF.

In an implementation, the SMF may send service information of the visited sensing application function requested by the request information to the AMF based on the indication of the request information.

In an implementation, the service information is pre-stored in the SMF;

or,

the service information is obtained by the SMF from the Policy Control Function (PCF).

The service information may be pre-stored in the SMF. The service information may also be pre-stored in the PCF. The SMF may receive service information of the visited sensing application function from the PCF.

In one embodiment, the SMF may send request information to the PCF, and receive service information of the visited sensing application function sent by the PCF to the SMF based on the request information.

In one embodiment, receiving, by the AMF, the request information sent by the UE includes:
receiving, by the AMF, a packet data unit (PDU) session establishment request message carrying the request information sent by the UE;
receiving, by the SMF, the request information sent by the AMF includes:
receiving, by the SMF, a PDU session context request carrying the request information sent by the AMF;
sending, by the SMF, the service information to the AMF in response to the request information includes:
sending, by the SMF, an N1N2 message transfer carrying the service information to the AMF in response to the PDU session context request;
sending, by the AMF, the service information to the UE includes:
sending, by the AMF, a PDU session response information carrying the service information to the UE, where the PDU session response information is associated with PDU session establishment accept.

Within the signal coverage of the VPLMN, the UE can request the service information of the visited sensing application function from the core network of the VPLMN during the process of establishing a PDU session in local-breakout.

During the process of establishing a PDU session, the UE may send a PDU session establishment request message (PDU Session Establishment Request) to the AMF. The UE may carry the request information in the PDU session establishment request message.

In an implementation, the request information carried in the PDU session establishment request message may include a DNN associated with the visited sensing application function requested by the UE.

In one embodiment, the request information is carried in a session management (SM) container.

The UE may set the request information in the SM container of the PDU session establishment request. Here, the SM container may be an N1 SM container.

After the AMF receives the PDU session establishment request message, the AMF may send a PDU session context request (Nsmf_PDUSession_CreateSMContext) to the SMF, and the PDU session context request may carry the request information.

In an implementation, the request information carried in the PDU session context request may include a DNN associated with the visited sensing application function requested by the UE.

In an implementation, the request information carried by the PDU session context request may include at least one of the following: an indicator for requesting service information of the visited sensing application function; and sensing capability information of the UE.

After receiving the PDU session establishment request message (PDU Session Establishment Request), the SMF may send a PDU Session Establishment Response message (PDU Session Establishment Response) to the AMF as a response.

In an implementation, the SMF may send an SM Policy Association Establishment request to the PCF. The SM Policy Association Establishment request may carry request information to request service information of the visited sensing application function from the PCF.

The response information sent by the PCF to the SMF in response to the SM Policy Association Establishment request may carry service information of the visited sensing application function.

In an implementation, the SMF may send an N4 Session Establishment Request to the User Plane Function (UPF) to establish a new PDU session for the UE.

In an implementation, the N4 Session Establishment Request carries a DNN associated with the visited sensing application function requested by the UE.

After SMF determines that N4 session is established, it can send N1N2 message transfer (such as Namf_Communication_N1N2Message Transfer) to AMF, and carry the obtained service information of the visited sensing application function in N1N2 message transfer.

In an implementation, the service information of the visited sensing application function carried in N1N2 message transfer can be pre-stored in SMF and/or received by SMF from PCF.

AMF can carry the service information of the visited sensing application function in the PDU session response information associated with PDU session establishment accept and send it to UE via the access network device. Then UE can obtain the service information of the visited sensing application function.

In one embodiment, sending, by the AMF, the PDU session response information carrying the service information to the UE includes:
sending, by the AMF, a N2 PDU session request carrying a non-access stratum NAS message to the access network device, where the NAS message carries the service information, and the NAS message is sent by the access network device to the UE.

After receiving the service information of the visited sensing application function in the N1N2 message transfer, the AMF may carry the service information of the visited sensing application function in the NAS message of the N2 PDU session request and send it to the access network device, and the access network device sends the NAS message to the UE, so that the UE may obtain the service information of the visited sensing application function.

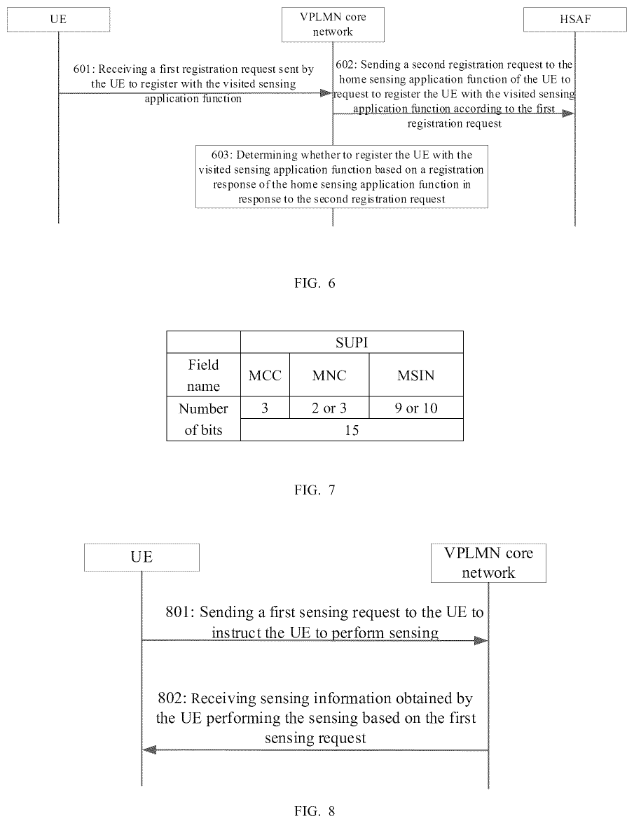

As shown in FIG. 6, the embodiment of the present disclosure provides an information processing method, executed by the core network of the VPLMN, including:
Step 601: receiving a first registration request sent by the UE to register with the visited sensing application function;
Step 602: sending a second registration request to the home sensing application function of the UE to request to register the UE with the visited sensing application function according to the first registration request;
Step 603: determining whether to register the UE with the visited sensing application function based on a registration response of the home sensing application function in response to the second registration request.

Steps 601-603 may be implemented individually or in combination with step 301 and/or step 302.

After obtaining the service information of the visited sensing application function, the UE may register with the visited sensing application function. Here, the service information may include the IP address of the visited sensing application function, etc.

The UE may send a first registration request to the visited sensing application function to request to register the UE with the visited sensing application function.

In an implementation, the first registration request may carry a UE identifier of the UE. The UE identifier may include at least one of the following: a Subscription Permanent Identifier (SUPI), etc.

The visited sensing application function may determine the UE to be registered based on the UE identifier of the UE in the first registration request.

In an implementation, the visited sensing application function may send a second registration request to the home sensing application function.

As shown in FIG. 7, in an implementation, the structure of the SUPI includes MCC, MNC, and MSIN. MCC represents a mobile country code. MNC represents a mobile network code. MSIN represents a mobile user identification number of the UE in the PLMN.

In an implementation, the visited sensing application function may find the home sensing application function in the HPLMN of the UE based on the MCC and MNC, and send a second registration request to the home sensing application function.

In an implementation, the second registration request may carry the UE identifier of the UE. The UE identifier may include at least one of the following: SUPI, etc.

The second registration request may be used for the visited sensing application function to request the home sensing application function to register the UE with the visited sensing application function. The second registration request may further be used for, but not limited to, the visited sensing application function to request from the home sensing application function: the permission of the UE to perform sensing, the type of sensing the UE is allowed to perform, the time the UE is allowed to perform sensing, the geographical range the UE is allowed to perform sensing, etc.

The home sensing application function may be based on the UE.

In an implementation, the second registration request may carry the UE identifier of the UE. The home sensing application function may determine the UE requesting to register with the visited sensing application function based on the UE identifier of the UE in the second registration request.

The home sensing application function may determine whether the UE is allowed to register with the visited sensing application function based on the service authority of the UE. The registration response is at least configured to indicate to the visited sensing application function whether the UE is allowed to register with the visited sensing application function. The visited sensing application function may determine whether the UE is allowed to register based on the registration response.

The registration response may also be configured to, but not limited to, indicate to the visited sensing application function: the permission of the UE to perform sensing, the type of sensing the UE is allowed to perform, the time the UE is allowed to perform sensing, the geographical range the UE is allowed to perform sensing, etc. The visited sensing application function may configure the sensing service of the UE based on the registration response.

In one embodiment, determining whether to register the UE with the visited sensing application function based on the registration response of the home sensing application function in response to the second registration request includes one of the following:
in response to receiving a first registration response sent by the home sensing application function indicating that the UE is allowed to register with the visited sensing application function, registering the UE with the visited sensing application function; and
in response to receiving a second registration response sent by the home sensing application function indicating that the UE is not allowed to register with the visited sensing application function, not registering the UE with the visited sensing application function.

The registration response may include a first registration response that allows the UE to register with the visited sensing application function, or a second registration response that does not allow the UE to register with the visited sensing application function.

When the visited sensing application function receives the first registration response, the UE is registered with the visited sensing application function. When the visited sensing application function receives the second registration response, the UE is not allowed to register with the visited sensing application function.

In one embodiment, the first registration response is sent by the home sensing application function in response to determining that there is register information indicating the UE is registered with the home sensing application function.

In an implementation, the home sensing application function records the registration relationship between the UE and the home sensing application function. In response to the registration relationship in the home sensing application function indicating that the UE is registered with the home sensing application function, the home sensing application function sends a registration response to the roaming home sensing application function, where the registration response indicates that the UE is allowed to register.

In one embodiment, the method further includes one of the following:
in response to determining to register the UE with the visited sensing application function, sending an allow registration response to the UE; and
in response to determining not to register the UE with the visited sensing application function, sending a disallow registration response to the UE.

When the visited sensing application function determines to register the UE with the visited sensing application function, sending an allow registration response to the UE. The UE can perform the sensing service through the visited sensing application function.

When the visited sensing application function does not allow the UE to register with the visited sensing application function, sending a disallow registration response to the UE.

In one embodiment, the second registration request is at least used for the home sensing application function to determine the corresponding relationship between the UE and the roaming sensing application function.

The second registration request sent by the visited sensing application function carries the UE identifier of the UE, so the home sensing application function can determine that the UE has a corresponding relationship with the roaming sensing application function. That is, if the home sensing application function determines that the UE can register with the roaming sensing application function, then in the subsequent sensing service processing process, the home sensing application function can configure the sensing service through the visited sensing application function.

As shown in FIG. 8, the embodiment of the present disclosure provides an information processing method, executed by the core network of the VPLMN, including:
Step 801: sending a first sensing request to the UE to instruct the UE to perform sensing;
Step 802: receiving sensing information obtained by the UE performing the sensing based on the first sensing request.

Step 801 and step 802 can be implemented individually, or can be implemented in combination with step 301, step 302, step 601, step 602, and step 603.

The roaming sensing application function can send the first sensing request to the UE to perform sensing services.

In an implementation, the first sensing request may carry sensing configuration parameters for performing sensing services. For example, the sensing configuration parameters may include at least one of the following: a sensing type, a sensing object, a sensing location, and sensing time.

Based on the first sensing request, the UE performs the sensing service, and sends the sensing information determined by performing the sensing service to the home sensing application function.

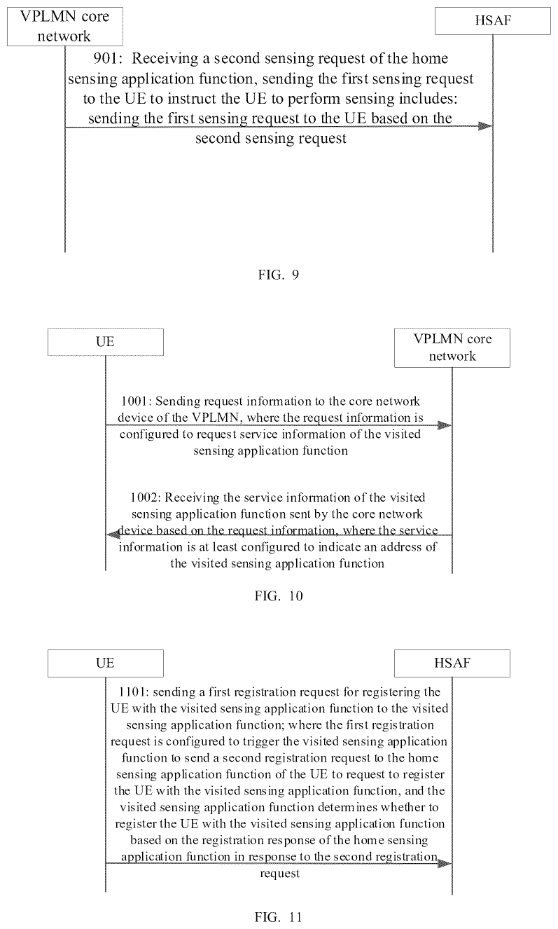

As shown in FIG. 9, the embodiment of the present disclosure provides an information processing method, executed by the core network of the VPLMN, including:
Step 901: receiving a second sensing request of the home sensing application function;
sending the first sensing request to the UE to instruct the UE to perform sensing includes: sending the first sensing request to the UE based on the second sensing request.

Step 901 may be implemented alone, or may be implemented in combination with step 301, step 302, step 601, step 602, step 603, step 801, and/or step 802.

The sensing service may be initiated by the home sensing application function. The home sensing application function may send the second sensing request to the visited sensing application function, triggering the visited sensing application function to send the first sensing request to the UE to perform the sensing service.

In one embodiment, the second sensing request at least includes a UE identifier indicating the UE.

The second sensing request may carry the UE identifier of the UE, such as SUPI, etc. The visited sensing application function may determine the UE corresponding to the sensing service requested by the second sensing request based on the UE identifier.

In an implementation, the second sensing request may carry sensing configuration parameters for performing the sensing service. For example, the sensing configuration parameters may include at least one of the following: a sensing type, a sensing object, a sensing location, and sensing time.

In one embodiment, the method further includes sending the sensing information to the home sensing application function.

In an implementation, in response to the first sensing request being sent based on the second sensing request of the home sensing application function, the visited sensing application function sends the received sensing information to the home sensing application function.

In an implementation, the visited sensing application function and the home sensing application function may perform data transmission based on a predetermined connection.

The data transmission based on the predetermined connection may include but is not limited to at least one of the following: transmission of sensing information, transmission of the second sensing request, and transmission of the second registration request.

In one embodiment, the sensing information includes at least one of the following:
metadata obtained by the UE performing the sensing; and
a sensing result obtained by the UE performing the sensing.

Here, the metadata may be the original data sensed by the UE for the sensing signal, for example: the signal quality parameter of the signal strength of the sensed sensing signal. Here, the sensing signal sensed by the UE may include at least one of the following: a sensing signal actively sent by the sensing object, and a sensing signal light reflected from the sensing object. Metadata may be configured to determine the sensing result. The sensing result may be the type, location, motion state, etc. of the sensing object obtained by processing and calculating the metadata.

As shown in FIG. 10, the embodiment of the present disclosure provides an information processing method, executed by the UE, including:
Step 1001: sending request information to the core network device of the visited public land mobile network VPLMN, where the request information is configured to request service information of the visited sensing application function;
Step 1002: receiving the service information of the visited sensing application function sent by the core network device based on the request information, where the service information is at least configured to indicate an address of the visited sensing application function.

The visited sensing application function may be configured to provide sensing services to the UE during the process of the UE roaming to the VPLMN. Here, the sensing service includes but is not limited to the sensing service based on the communication signal, such as environmental sensing based on the communication signal, etc.

In an implementation, the service information includes location information of the visited sensing application function, such as an IP address. The visited sensing application function may be deployed in a sensing application server. The UE may access the visited sensing application function and/or register with the visited sensing application function based on the service information. The service information also includes access information of the visited sensing application function. The access information may include information required by the UE for sensing through the visited sensing application function. The access information may include, but is not limited to: access authentication information of the visited sensing application function, type information of the visited sensing application function, etc.

As shown in FIG. 4, in a non-roaming situation, the UE performs the sensing service through the home sensing application function in the HPLMN. As shown in FIG. 5, in a roaming situation, the UE leaves the signal coverage of the HPLMN and needs to perform the sensing service through the visited sensing application function of the VPLMN.

The UE performs the sensing service through the visited sensing application function of the VPLMN and needs to obtain service information of the visited sensing application function, such as location information, etc.

The UE may send a request information to the core network of the VPLMN to request service information of the visited sensing application function. The request information may be an indicator, requesting the core network for service information of the visited sensing application function. The request information may also include associated information of the requested visited sensing application function, which limits the requested visited sensing application function. For example, the request information may include type information of the visited sensing application function, etc., to indicate the type of the requested visited sensing application function.

In one embodiment, the request information is configured to request a data network name DNN associated with the visited sensing application function.

The visited sensing application function may have a specific DNN, and the UE may send the DNN associated with the visited sensing application function to the core network of the VPLMN to request the service information of the visited sensing application function from the core network of the VPLMN.

In an implementation, the request information may also be implicitly indicated by the capability information of the UE, and the UE may report its own sensing capability to the core network of the VPLMN. When the core network of the VPLMN determines that the UE has the sensing capability, the service information of the visited sensing application function may be sent to the UE.

In an implementation, the request information may be carried in an uplink NAS message, and forwarded by the access network device to the core network device. Here, the access network device may include a base station.

In an implementation, the request information may be for a specific sensing application function. For example, the request information may include type indication information of the requested sensing application function. The request information may also be for all sensing application functions, and the request information is configured to request all sensing application functions available to the UE.

After obtaining the request information, the core network of the VPLMN may send the service information of the visited sensing application function to the UE.

In an implementation, the service information of the visited sensing application function may be determined based on the request information. The core network of the VPLMN may send the service information of the sensing application function of the specified type to the UE according to the indication of the request information. The core network of the VPLMN may send the service information of the sensing application function that the current UE can use to the UE according to the indication of the request information.

The service information of the visited sensing application function may be carried in the downlink NAS message and forwarded to the UE by the access network device. The service information of the visited sensing application function sent to the UE may be service information of one or more visited sensing application functions.

In an implementation, the service information may be pre-stored in the core network of the VPLMN.

The service information of the visited sensing application function can be pre-stored in the core network. For example, the service information of the visited sensing application function can be pre-stored in network elements such as AMF and SMF. The core network of the VPLMN can obtain the stored service information of the visited sensing application function, and/or obtain the service information of the visited sensing application function from other network elements of the core network, and send it to the UE. For example, the core network of the VPLMN can obtain the service information of the visited sensing application function from the SMF.

In this way, the UE sends the request information to the core network of the VPLMN, and the core network of the VPLMN sends the service information of the visited sensing application function to the UE in response to the request information, so that the UE can obtain the service information of the visited sensing application function, which provides a basis for the UE to perform the sensing service during roaming.

In one embodiment, the sending the request information to the core network device of the VPLMN includes:
sending the request information to the access and mobility management function AMF of the core network device, where the request information is sent by the AMF to the session management function SMF of the core network device;
receiving the service information of the visited sensing application function sent by the core network device based on the request information includes:
receiving the service information sent by the AMF, where the service information is sent by the SMF to the AMF.

The UE may send a request information to the AMF of the core network, and the AMF forwards the request information to the SMF.

The service information of the visited sensing application function sent by the AMF to the UE may be received from the SMF. The AMF may send the request information to the SMF, and the SMF sends the service information of the visited sensing application function to the AMF.

In an implementation, the SMF may send the service information of the visited sensing application function requested by the request information to the AMF based on the indication of the request information.

In an implementation, the service information is pre-stored in the SMF;

or,

the service information is obtained by the SMF from a policy control function (PCF).

The service information may be pre-stored in the SMF. The service information may also be pre-stored in the PCF. The SMF may receive service information of the visited sensing application function from the PCF.

In one embodiment, the SMF may send request information to the PCF, and receive service information of the visited sensing application function sent by the PCF to the SMF based on the request information.

In one embodiment, sending the request information to the access and mobility management function AMF of the core network device includes:
sending a packet data unit PDU session establishment request message carrying the request information to the AMF;
receiving the service information sent by the AMF includes:
receiving a PDU session response message carrying the service information sent by the AMF, where the PDU session response message is associated with PDU session establishment accept.

Within the signal coverage of the VPLMN, the UE can request the service information of the visited sensing application function from the core network of the VPLMN during the process of establishing a PDU session in Local-Breakout.

During the process of establishing the PDU session, the UE may send a PDU session establishment request message (PDU Session Establishment Request) to the AMF. The UE may carry the request information in the PDU session establishment request message.

In an implementation, the request information carried by the PDU session establishment request message may include a DNN associated with the visited sensing application function requested by the UE.

In one embodiment, the request information is carried in a session management (SM) container.

The UE can set the request information in the SM container of the PDU session establishment request. Here, the SM container can be an N1 SM container.

After the AMF receives the PDU session establishment request message, the AMF can send a PDU session context request (Nsmf_PDUSession_CreateSMContext) to the SMF, and the PDU session context request can carry the request information.

In an implementation, the request information carried by the PDU session context request may include a DNN associated with the visited sensing application function requested by the UE.

In an implementation, the request information carried by the PDU session context request may include at least one of the following: an indicator for requesting service information of the visited sensing application function; and sensing capability information of the UE.

After receiving the PDU session establishment request message (PDU Session Establishment Request), the SMF may send a PDU Session Establishment Response message (PDU Session Establishment Response) to the AMF as a response.

In an implementation, the SMF may send an SM Policy Association Establishment request to the PCF. The SM Policy Association Establishment request may carry request information to request service information of the visited sensing application function from the PCF.

The response information sent by the PCF to the SMF in response to the SM Policy Association Establishment Request may carry service information of the visited sensing application function.

In an implementation, the SMF may send an N4 session establishment request to the user plane function (UPF) to establish a new PDU session for the UE.

In an implementation, the N4 session establishment request carries a DNN associated with the visited sensing application function requested by the UE.

After SMF determines that the N4 session is established, it may send an N1N2 message transfer (such as Namf_Communication_N1N2Message Transfer) to AMF, and carry the obtained service information of the visited sensing application function in the N1N2 message transfer.

In an implementation, the service information of the visited sensing application function carried in the N1N2 message transfer may be pre-stored in the SMF and/or received by the SMF from the PCF.

AMF may carry the service information of the visited sensing application function in the PDU session response information associated with PDU session establishment accept and send it to the UE via the access network device. Then the UE can obtain the service information of the visited sensing application function.

In one embodiment, the request information is carried in the session management SM container.

In one embodiment, receiving the PDU session response information sent by the AMF and carrying the service information includes:
receiving a NAS message sent by the access network device, where the NAS message carries the service information, and the NAS message is carried in the N2 PDU session request sent by the AMF to the access network device.

After receiving the service information of the visited sensing application function in the N1N2 message transfer, the AMF may carry the service information of the visited sensing application function in the NAS message of the N2 PDU session request and sent it to the access network device, and the access network device sends the NAS message to the UE, so that the UE can obtain the service information of the visited sensing application function.

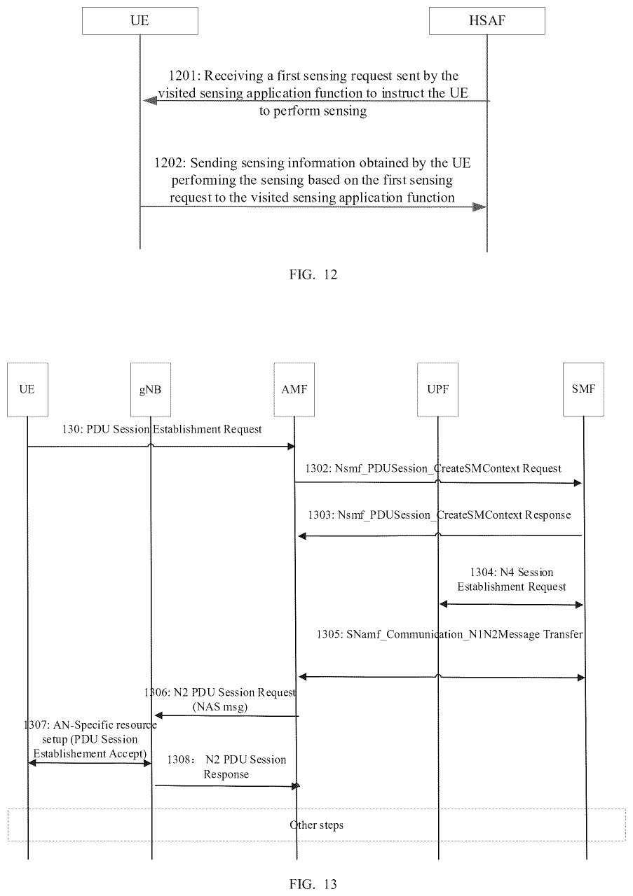

As shown in FIG. 11, the embodiment of the present disclosure provides an information processing method, executed by a UE, including:
Step 1101: sending a first registration request for registering the UE with the visited sensing application function to the visited sensing application function; where the first registration request is configured to trigger the visited sensing application function to send a second registration request to the home sensing application function of the UE to request to register the UE with the visited sensing application function, and the visited sensing application function determines whether to register the UE with the visited sensing application function based on the registration response of the home sensing application function in response to the second registration request.

Step 1101 can be implemented alone or in combination with step 1001 and/or step 1002.

After obtaining the service information of the visited sensing application function, the UE can register with the visited sensing application function. Here, the service information may include the IP address of the visited sensing application function, etc.

The UE can send a first registration request to the visited sensing application function to request to register the UE with the visited sensing application function.

In an implementation, the first registration request may carry a UE identifier of the UE. The UE identifier may include at least one of the following: a Subscription Permanent Identifier (SUPI), etc.

The visited sensing application function may determine the UE to be registered based on the UE identifier of the UE in the first registration request.

In an implementation, the visited sensing application function may send a second registration request to the home sensing application function.

As shown in FIG. 7, in an implementation, the structure of the SUPI includes MCC, MNC, and MSIN. MCC represents a mobile country code. MNC represents a mobile network code. MSIN represents a mobile user identification number of the UE in the PLMN.

In an implementation, the visited sensing application function may find the home sensing application function in the HPLMN of the UE based on the MCC and MNC, and send a second registration request to the home sensing application function.

In an implementation, the second registration request may carry the UE identifier of the UE. The UE identifier may include at least one of the following: SUPI, etc.

The second registration request may be used for the visited sensing application function to request the home sensing application function to register the UE with the visited sensing application function. The second registration request may further be used for, but not limited to, the visited sensing application function to request from the home sensing application function: the permission of the UE to perform sensing, the type of sensing the UE is allowed to perform, the time the UE is allowed to perform sensing, the geographical range the UE is allowed to perform sensing, etc.

The home sensing application function may be based on the UE.

In an implementation, the second registration request may carry the UE identifier of the UE. The home sensing application function may determine the UE requesting to register with the visited sensing application function based on the UE identifier of the UE in the second registration request.

The home sensing application function may determine whether the UE is allowed to register with the visited sensing application function based on the service authority of the UE. The registration response is at least configured to indicate to the visited sensing application function whether the UE is allowed to register with the visited sensing application function. The visited sensing application function may determine whether the UE is allowed to register based on the registration response.

The registration response may also be configured to, but not limited to, indicate to the visited sensing application function: the permission of the UE to perform sensing, the type of sensing the UE is allowed to perform, the time the UE is allowed to perform sensing, the geographical range the UE is allowed to perform sensing, etc. The visited sensing application function may configure the sensing service of the UE based on the registration response.

In one embodiment, the method further includes one of the following:
receiving an allow registration response sent by the visited sensing application function to allow the UE to register with the visited sensing application function, where the allow registration response is sent by the visited sensing application function after receiving a first registration response sent by the home sensing application function indicating that the UE is allowed to register with the visited sensing application function;
receiving a disallow registration response sent by the visited sensing application function to not allow the UE to register with the visited sensing application function, where the disallow registration response is sent by the visited sensing application function after receiving a second registration response sent by the home sensing application function indicating that the UE is not allowed to register with the visited sensing application function.

The registration response may include: a first registration response to allow the UE to register with the visited sensing application function, or a second registration response to not allow the UE to register with the visited sensing application function.

When the visited sensing application function receives the first registration response, the UE is registered with the visited sensing application function. When the visited sensing application function receives the second registration response, the UE is not allowed to register with the visited sensing application function.

When the visited sensing application function determines to register the UE with the visited sensing application function, an allow registration response is sent to the UE. The UE can perform the sensing service through the visited sensing application function.

When the visited sensing application function does not allow the UE to be registered with the visited sensing application function, a disallow registration response is sent to the UE.

In one embodiment, the first registration response is sent by the home sensing application function in response to determining that there is register information indicating the UE is registered with the home sensing application function.

In an implementation, the home sensing application function records the registration relationship between the UE and the home sensing application function. In response to the registration relationship in the home sensing application function indicating that the UE is registered with the home sensing application function, the home sensing application function sends a registration response to the roaming home sensing application function, where the registration response indicates that the UE is allowed to register.

In one embodiment, the second registration request is at least used for the home sensing application function to determine the corresponding relationship between the UE and the visited sensing application function.

The second registration request sent by the visited sensing application function carries the UE identifier of the UE, so the home sensing application function can determine that the UE has a corresponding relationship with the visited sensing application function. That is, if the home sensing application function determines that the UE can register with the visited sensing application function, then in the subsequent sensing service processing process, the home sensing application function can configure the sensing service through the visited sensing application function.

As shown in FIG. 12, the embodiment of the present disclosure provides an information processing method, executed by a UE, including:
Step 1201: receiving a first sensing request sent by the visited sensing application function to instruct the UE to perform sensing;
Step 1202: sending sensing information obtained by the UE performing the sensing based on the first sensing request to the visited sensing application function.

Steps 1201 and 1202 can be implemented individually, or can be implemented in combination with steps 1001, 1002, and/or 1101.

The visited sensing application function can send a first sensing request to the UE to perform a sensing service.

In an implementation, the first sensing request can carry a sensing configuration parameter for performing a sensing service. For example, the sensing configuration parameter can include at least one of the following: a sensing type, a sensing object, a sensing location, and sensing time.

Based on the first sensing request, the UE performs the sensing service, and sends the sensing information determined by performing the sensing service to the home sensing application function.

In one embodiment, the first sensing request is sent by the visited sensing application function to the UE based on the second sensing request received from the home sensing application function.

The sensing service can be initiated by the home sensing application function. The home sensing application function may send the second sensing request to the visited sensing application function, triggering the visited sensing application function to send the first sensing request to the UE to perform the sensing service.

In an implementation, in response to the first sensing request being sent based on the second sensing request of the home sensing application function, the visited sensing application function sends the received sensing information to the home sensing application function.

In an implementation, the visited sensing application function and the home sensing application function may perform data transmission based on a predetermined connection.

The data transmission based on the predetermined connection may include but is not limited to at least one of the following: transmission of sensing information, transmission of the second sensing request, and transmission of the second registration request.

In one embodiment, the second sensing request at least includes a UE identifier indicating the UE.

The second sensing request may carry the UE identifier of the UE, such as SUPI, etc. The visited sensing application function may determine the UE corresponding to the sensing service requested by the second sensing request based on the UE identifier.

In an implementation, the second sensing request may carry the sensing configuration parameters for performing the sensing service. For example, the sensing configuration parameters may include at least one of the following: a sensing type, a sensing object, a sensing location, and sensing time.

In one embodiment, the sensing information includes at least one of the following:
metadata obtained by the UE performing the sensing; and
a sensing result obtained by the UE performing the sensing.

Here, the metadata may be the original data sensed by the UE for the sensing signal, for example: the signal quality parameter of the signal strength of the sensed sensing signal. Here, the sensing signal sensed by the UE may include at least one of the following: a sensing signal actively sent by the sensing object, and a sensing signal light reflected from the sensing object. Metadata may be configured to determine the sensing result. The sensing result may be the type, position, motion state, etc. of the sensing object obtained by processing and calculating the metadata.

In order to further explain any embodiment of the present disclosure, several specific embodiments are provided below.

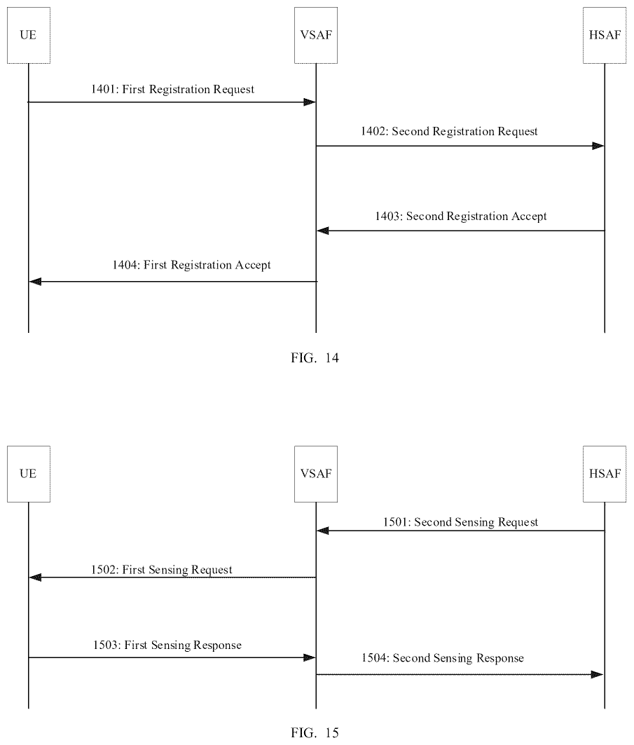

As shown in FIG. 13, the method for a roaming UE to establish a local-breakout PDU session for sensing can be applied to the UE roaming scenario shown in FIG. 2, including:
Step 1301: the UE initiates the PDU session establishment process requested by the UE by sending a NAS message containing a PDU Session Establishment Request in the N1 SM container. The PDU Session Establishment Request includes a DNN corresponding to the sensing application service requested by the UE. AMF receives a PDU session establishment request.
Step 1302: AMF selects an SMF and sends Nsmf_PDUSession_CreateSMContext Request to the SMF, including the sensing service corresponding to UE Requested DNN;
Step 1303: SMF receives Nsmf_PDUSession_CreateSMContext Request and responds to AMF;
Step 1304: SMF selects a local UPF in the VPLMN based on the UE Requested DNN corresponding to the received sensing service, and then sends an N4 Session Establishment Request to UPF, where the N4 Session Establishment Request includes the UE Requested DNN corresponding to the sensing service, and establishes a new PDU session for the UE.
Step 1305: SMF sends Namf_Communication_N1N2Message Transfer to AMF, which includes the IP address of V-SAF;
Step 1306: AMF receives Namf_Communication_N1N2Message and sends N2 PDU Session Request (NAS message) to gNB, where the NAS message includes the IP address of V-SAF;
Step 1307: During AN specific resource setting (PDU session establishment accept), gNB forwards the NAS message provided in step 1306 to UE. UE receives the IP address of V-SAF;
Step 1308: gNB sends N2 PDU Session Response to AMF.

The following other steps are performed as usual. UE can register and interact with V-SAF based on the established Local-breakout PDU session and the received IP address of V-SAE

As shown in FIG. 14, the steps of registering the UE with the visited sensing application function include:
Step 1401: UE sends a first registration request to V-SAF according to the received V-SAF IP address, and the first registration request includes UE ID (SUPI);
Step 1402: V-SAF finds H-SAF in the HPLMN of UE according to MCC and MNC in SUPI, and sends a second registration request to H-SAF, and the second registration request includes UE ID (SUPI);
Step 1403: H-SAF records the Registration relationship between UE and V-SAF, and sends a second registration accept to V-SAF;
Step 1404: V-SAF sends a first registration accept to UE.

As shown in FIG. 15, the steps of UE performing sensing service through the home sensing application function include:

The process of UE performing sensing according to the request of H-SAF is as follows:
Step 1501: There is a second sensing request from H-SAF to UE. According to the relationship record between UE and V-SAF, H-SAF sends a Sensing Request to V-SAF, which includes UE ID (SUPI);
Step 1502: V-SAFE sender sends a first sensing request to UE;
Step 1503: UE performs sensing and sends the sensing result or metadata to V-SAF through a first sensing response;
Step 1504: V-SAF sends a second sensing response to H-SAF, including the sensing result or metadata from UE. V-SAF can process the sensing result or metadata according to the home policy and send the processing result to H-SAF. H-SAF may change the original sensing result or metadata from UE.

As shown in FIG. 16, the steps of UE performing the sensing service through the roaming sensing application function include:
Step 1601: there is a sensing service request from V-SAF to UE. The V-SAF selects a UE and sends a first sensing request to the UE, which includes sensing requirements, e.g., location and time;
Step 1602: UE performs sensing at the location and time according to the received first sensing request, and sends the sensing result or metadata to the V-SAF through a first sensing response.

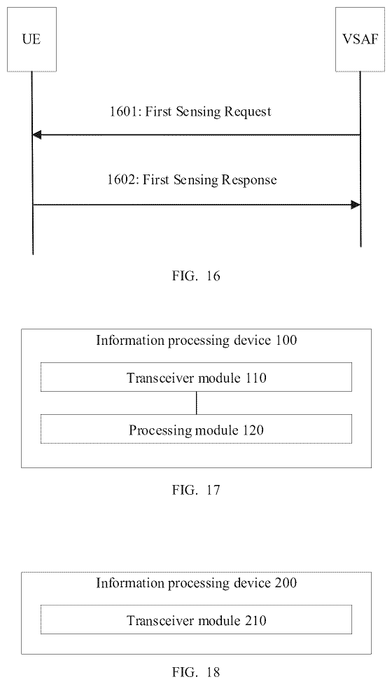

As shown in FIG. 17, the embodiment of the present disclosure provides an information processing device 100, applied to a core network device of a visited public land mobile network VPLMN, including:
a transceiver module 110 configured to receive request information sent by a user equipment UE, where the request information is configured to request service information of a roaming sensing application function;
the transceiver module 110 is further configured to send the service information of the roaming sensing application function to the UE based on the request information, where the service information is at least configured to indicate an address of the roaming sensing application function.

In one embodiment, the transceiver module 110 is specifically configured as at least one of the following:
an access and mobility management function AMF of the core network device receives the request information sent by the UE;
a session management function SMF of the core network device receives the request information sent by the AMF.

The transceiver module 110 is specifically configured as at least one of the following:
the SMF sends the service information to the AMF in response to the request information;
the AMF sends the service information to the UE.

In one embodiment, the transceiver module 110 is specifically configured as follows:
the AMF receives a packet data unit PDU session establishment request message carrying the request information sent by the UE.

The transceiver module 110 is specifically configured as follows:
the SMF receives a PDU session context request carrying the request information sent by the AMF.

The transceiver module 110 is specifically configured as follows:
the SMF sends an N1N2 message transfer carrying the service information to the AMF in response to the PDU session context request.

The transceiver module 110 is specifically configured as follows:
the AMF sends a PDU session response message carrying the service information to the UE, where the PDU session response message is associated with PDU session establishment accept.

In one embodiment, the request information is carried in a session management SM container.

In one embodiment, the transceiver module 110 is specifically configured as follows:
the AMF sends an N2 PDU session request carrying a non-access stratum NAS message to the access network device, where the NAS message carries the service information, and the NAS message is sent by the access network device to the UE.

In one embodiment, the transceiver module 110 is further configured to perform at least one of the following:
receiving a first registration request sent by the UE to register with the visited sensing application function;
sending a second registration request to the home sensing application function of the UE to request to register the UE with the visited sensing application function according to the first registration request.

The device 100 further includes a processing module 120, configured to determine whether to register the UE with the visited sensing application function based on a registration response of the home sensing application function in response to the second registration request.

In one embodiment, the processing module 120 is specifically configured to perform one of the following:
in response to receiving a first registration response sent by the home sensing application function indicating that the UE is allowed to register with the visited sensing application function, registering the UE with the visited sensing application function; and
in response to receiving a second registration response sent by the home sensing application function indicating that the UE is not allowed to register with the visited sensing application function, not registering the UE with the visited sensing application function.

In one embodiment, the transceiver module 110 is further configured as one of the following:
in response to determining to register the UE with the visited sensing application function, sending an allow registration response to the UE; and
in response to determining not to register the UE with the visited sensing application function, sending a disallow registration response to the UE.

In one embodiment, the first registration response is sent by the home sensing application function in response to determining that there is registration information indicating UE is registered with the home sensing application function.

In one embodiment, the second registration request is at least used for the home sensing application function to determine the corresponding relationship between the UE and the visited sensing application function.

In one embodiment, the transceiver module 110 is further configured to:
send a first sensing request to the UE to instruct the UE to perform sensing; and
receive sensing information obtained by the UE performing the sensing based on the first sensing request.

In one embodiment, the transceiver module 110 is further configured to:
receive a second sensing request of the home sensing application function.
The transceiver module 110 is specifically configured to:
send the first sensing request to the UE based on the second sensing request.

In one embodiment, the second sensing request at least includes a UE identifier indicating the UE.

In one embodiment, the transceiver module 110 is further configured to:
send the sensing information to the home sensing application function.

In one embodiment, the sensing information includes at least one of the following:
metadata obtained by the UE performing the sensing;
a sensing result obtained by the UE performing the sensing.

In one embodiment, the request information is configured to request a data network name DNN associated with a visited sensing application function.

As shown in FIG. 18, the embodiment of the present disclosure provides an information processing device 200, applied to a UE, including:
a transceiver module 210 configured to send a request information to a core network device of a visited public land mobile network VPLMN, where the request information is configured to request service information of a visited sensing application function;
the transceiver module 210 is further configured to receive the service information of the visited sensing application function sent by the core network device based on the request information, where the service information is at least configured to indicate an address of the visited sensing application function.

In one embodiment, the transceiver module 210 is specifically configured to:
send the request information to the access and mobility management function AMF of the core network device, where the request information is sent by the AMF to a session management function SMF of the core network device.

The transceiver module 210 is specifically configured to receive the service information sent by the AMF, where the service information is sent by the SMF to the AMF.

In one embodiment, the transceiver module 210 is specifically configured to send a packet data unit PDU session establishment request message carrying the request information to the AMF.

The transceiver module 210 is specifically configured to receive a PDU session response message carrying the service information sent by the AMF, where the PDU session response information is associated with PDU session establishment accept.

In one embodiment, the request information is carried in a session management SM container.

In one embodiment, the transceiver module 210 is specifically configured to receive a NAS message sent by the access network device, where the NAS message carries the service information, and the NAS message is carried in the N2 PDU session request sent by the AMF to the access network device.

In one embodiment, the transceiver module 210 is further configured to:
send a first registration request for registering the UE with the visited sensing application function to the visited sensing application function; where the first registration request is configured to trigger the visited sensing application function to send a second registration request to the home sensing application function of the UE to request to register the UE with the visited sensing application function, and the visited sensing application function determines whether to register the UE with the visited sensing application function based on the registration response of the home sensing application function in response to the second registration request.

In one embodiment, the transceiver module 210 is further configured to:
receive an allow registration response sent by the visited sensing application function to allow the UE to register with the visited sensing application function, where the allow registration response is sent by the visited sensing application function after receiving a first registration response sent by the home sensing application function indicating that the UE is allowed to register with the visited sensing application function; and
receive a disallow registration response sent by the visited sensing application function to disallow the UE to register with the visited sensing application function, where the disallow registration response is sent by the visited sensing application function after receiving a first registration response sent by the home sensing application function indicating that the UE is not allowed to register with the visited sensing application function.

In one embodiment, the first registration response is sent by the home sensing application function in response to determining that there is registration information indicating the UE is registered with the home sensing application function.

In one embodiment, the second registration request is at least used for the home sensing application function to determine the corresponding relationship between the UE and the visited sensing application function.

In one embodiment, the transceiver module 210 is further configured to:
receive a first sensing request sent by the visited sensing application function to instruct the UE to perform sensing;
send sensing information obtained by the UE performing the sensing based on the first sensing request to the visited sensing application function.

In one embodiment, the first sensing request is sent by the visited sensing application function to the UE based on the second sensing request received from the home sensing application function.

In one embodiment, the second sensing request at least includes a UE identifier indicating the UE.

In one embodiment, the sensing information includes at least one of the following:
metadata obtained by the UE performing the sensing; and
a sensing result obtained by the UE performing the sensing.

In one embodiment, the request information is configured to request a data network name DNN associated with the visited sensing application function.

It should be noted that those skilled in the art can understand that the device provided in the embodiment of the present disclosure can be executed alone or together with some devices in the embodiment of the present disclosure or some devices in related art.

Regarding the device in the above embodiment, the specific manner in which each module performs the operation has been described in detail in the embodiment of the method, and will not be elaborated here.

The embodiment of the present disclosure provides a communication device, including:
a processor; and
a memory for storing processor executable instructions;
where the processor is configured to implement the information processing method of any embodiment of the present disclosure when running the executable instructions.

In one embodiment, the communication device may include but is not limited to at least one of: UE and a network device. Here, the network device may include a core network or an access network device, etc. Here, the access network device may include a base station; and the core network may include AMF, SMF M.

The processor may include various types of storage media, which are non-temporary computer storage media, and can continue to store information stored thereon after the user equipment is powered off.

The processor can be connected to the memory through a bus, etc., for reading an executable program stored on the memory, for example, at least one of the methods shown in FIGS. 3, 6, 8 to 16.

The embodiment of the present disclosure also provides a computer storage medium. The computer storage medium stores a computer executable program, and when the executable program is executed by the processor, the information processing method of any embodiment of the present disclosure is implemented, e.g., at least one of the methods shown in FIGS. 3, 6, 8 to 16 is implemented.

Regarding the device or storage medium in the above embodiment, the specific manner in which each module performs the operation has been described in detail in the embodiment of the method, and will not be elaborated here.

FIG. 19 is a block diagram of a user equipment 3000 according to an example embodiment. For example, the user equipment 3000 may be a mobile phone, a computer, a digital broadcast user equipment, a messaging device, a game console, a tablet device, a medical device, a fitness device, a personal digital assistant, etc.

Referring to FIG. 19, the user equipment 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operation of the user equipment 3000, such as operations associated with display, phone calls, data communications, camera operations, and recording operations. The processing component 3002 may include one or more processors 3020 to execute instructions to complete all or part of the steps of the above method. In addition, the processing component 3002 may include one or more modules to facilitate interaction between the processing component 3002 and other components. For example, the processing component 3002 may include a multimedia module to facilitate interaction between the multimedia component 3008 and the processing component 3002.

The memory 3004 is configured to store various types of data to support operations on the user equipment 3000. Examples of such data include instructions for any application or method operating on the user equipment 3000, contact data, phone book data, messages, pictures, videos, etc. The memory 3004 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 3006 provides power to various components of the user equipment 3000. The power component 3006 may include a power management system, one or more power supplies, and other components associated with generating, managing, and distributing power for the user equipment 3000.

The multimedia component 3008 includes a screen that provides an output interface between the user equipment 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 3008 includes a front camera and/or a rear camera. When the user equipment 3000 is in an operating mode, such as a shooting mode or a video mode, the front camera and/or the rear camera may receive external multimedia data. Each of the front camera and the rear camera may be a fixed optical lens system or have focal length and optical zoom capabilities.

The audio component 3010 is configured to output and/or input audio signals. For example, the audio component 3010 includes a microphone (MIC), which is configured to receive external audio signals when the user equipment 3000 is in an operating mode, such as a call mode, a recording mode, and a voice recognition mode. The received audio signal can be further stored in the memory 3004 or sent via the communication component 3016. In some embodiments, the audio component 3010 also includes a speaker for outputting audio signals.

The I/O interface 812 provides an interface between the processing component 3002 and a peripheral interface module. The peripheral interface module can be a keyboard, a click wheel, a button, etc. These buttons may include, but are not limited to: a home button, a volume button, a start button, and a lock button.

The sensor component 3014 includes one or more sensors for providing various aspects of status assessment for the user equipment 3000. For example, the sensor assembly 3014 can detect the open/closed state of the device 3000, the relative positioning of components, such as the display and keypad of the user equipment 3000. The sensor assembly 3014 can also detect the position change of the user equipment 3000 or a component of the user equipment 3000, the presence or absence of contact between the user and the user equipment 3000, the orientation or acceleration/deceleration of the user equipment 3000 and the temperature change of the user equipment 3000. The sensor assembly 3014 may include a proximity sensor configured to detect the presence of a nearby object without any physical contact. The sensor assembly 3014 may also include a light sensor, such as a CMOS or CCD image sensor, for use in imaging applications. In some embodiments, the sensor assembly 3014 may also include an acceleration sensor, a gyroscope sensor, a magnetic sensor, a pressure sensor or a temperature sensor.

The communication component 3016 is configured to facilitate wired or wireless communication between the user equipment 3000 and other devices. The user equipment 3000 can access a wireless network based on a communication standard, such as WiFi, 4G or 5G, or a combination thereof. In an example embodiment, the communication component 3016 receives a broadcast signal or broadcast-related information from an external broadcast management system via a broadcast channel. In an example embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, the user equipment 3000 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the above method.

In an example embodiment, a non-temporary computer-readable storage medium including instructions is also provided, such as a memory 3004 including instructions, and the instructions can be executed by a processor 3020 of a user equipment 3000 to complete the above method. For example, the non-temporary computer-readable storage medium can be a ROM, a random-access memory (RAM), a CD-ROM, a tape, a floppy disk, and an optical data storage device, etc.

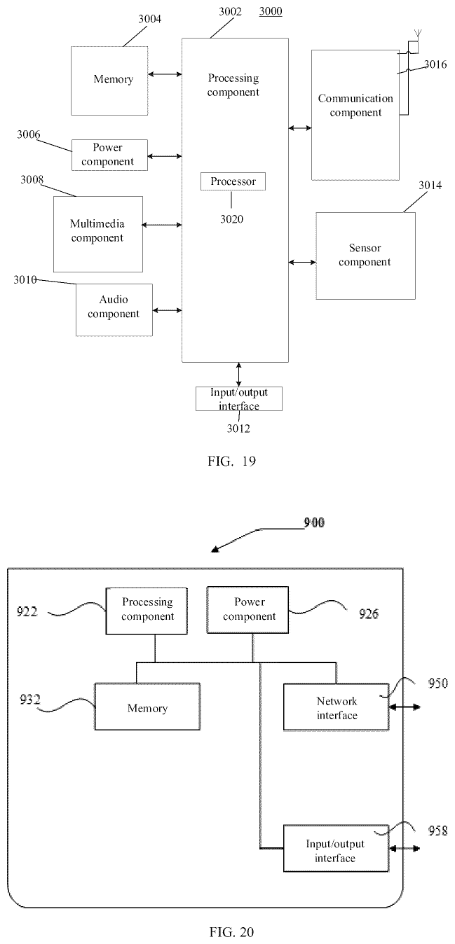

As shown in FIG. 20, an embodiment of the present disclosure shows a structure of a base station. For example, a base station 900 can be provided as a network side device. Referring to FIG. 20, the base station 900 includes a processing component 922, which further includes one or more processors, and a memory resource represented by a memory 932 for storing instructions executable by the processing component 922, such as an application. The application stored in the memory 932 may include one or more modules each corresponding to a set of instructions. In addition, the processing component 922 is configured to execute instructions to execute the above method, and any method applied in the base station.

The base station 900 may also include a power supply component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™ or the like.

Other embodiments of the present disclosure will be readily apparent to those skilled in the art after considering the specification and practicing the disclosure herein. The present disclosure is intended to cover any variation, use or adaptation of the present disclosure that follows the general principles of the present disclosure and includes common knowledge or conventional technical means in the art that are not disclosed in the present disclosure. The description and embodiments are to be regarded as examples only, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

1. An information processing method, performed by a core network device of a visited public land mobile network (VPLMN), comprising:
receiving request information sent by a user equipment (UE), wherein the request information is configured to request service information of a visited sensing application function; and
sending the service information of the visited sensing application function to the UE based on the request information, wherein the service information is at least configured to indicate an address of the visited sensing application function.

2. The method according to claim 1, wherein receiving the request information sent by the UE comprises at least one of:
receiving, by an access and mobility management function (AMF) of the core network device, the request information sent by the UE; and
receiving, by a session management function (SMF) of the core network device, the request information sent by the AMF;
sending the service information of the visited sensing application function to the UE based on the request information comprises at least one of:
sending, by the SMF, the service information to the AMF in response to the request information; and
sending, by the AMF, the service information to the UE.

3. The method according to claim 2, wherein,
receiving, by the AMF, the request information sent by the UE comprises:
receiving, by the AMF, a packet data unit (PDU) session establishment request message carrying the request information sent by the UE;
receiving, by the SMF, the request information sent by the AMF comprises:
receiving, by the SMF, a PDU session context request carrying the request information sent by the AMF;
sending, by the SMF, the service information to the AMF in response to the request information comprises:
sending, by the SMF, an N1N2 message transfer carrying the service information to the AMF in response to the PDU session context request;
sending, by the AMF, the service information to the UE comprises:
sending, by the AMF, PDU session response information carrying the service information to the UE, wherein the PDU session response information is associated with PDU session establishment accept.

4. (canceled)

5. The method according to claim 3, wherein sending, by the AMF, the PDU session response message carrying the service information to the UE comprises:
sending, by the AMF, an N2 PDU session request carrying a non-access stratum (NAS) message to an access network device, wherein the NAS message carries the service information, and the NAS message is sent by the access network device to the UE.

6. The method according to claim 1, further comprising at least one of:
receiving a first registration request sent by the UE to register with the visited sensing application function;
sending a second registration request to a home sensing application function of the UE to request to register the UE with the visited sensing application function based on the first registration request; and
determining whether to register the UE with the visited sensing application function based on a registration response of the home sensing application function in response to the second registration request.

7. The method according to claim 6, wherein determining whether to register the UE with the visited sensing application function based on the registration response of the home sensing application function in response to the second registration request comprises one of:
in response to receiving a first registration response sent by the home sensing application function indicating that the UE is allowed to register with the visited sensing application function, registering the UE with the visited sensing application function; and
in response to receiving a second registration response sent by the home sensing application function indicating that the UE is not allowed to register with the visited sensing application function, not registering the UE with the visited sensing application function.

8. The method according to claim 7, further comprising one of:
in response to determining to register the UE with the visited sensing application function, sending an allow registration response to the UE; and
in response to determining not to register the UE with the visited sensing application function, sending a disallow registration response to the UE.

9. The method according to claim 7, wherein the first registration response is sent by the home sensing application function in response to determining that there is registration information indicating the UE is registered with the home sensing application function.

10. The method according to claim 7, wherein the second registration request is at least used for the home sensing application function to determine a corresponding relationship between the UE and the visited sensing application function.

11. The method according to claim 6, further comprising:
sending a first sensing request to the UE to instruct the UE to perform sensing; and
receiving sensing information obtained by the UE performing the sensing based on the first sensing request.

12. The method according to claim 11, further comprising:
receiving a second sensing request of the home sensing application function;
sending the first sensing request to the UE to instruct the UE to perform sensing comprises:
sending the first sensing request to the UE based on the second sensing request.

13.-16. (canceled)

17. An information processing method, performed by a user equipment (U), comprising:
sending request information to a core network device of a visited public land mobile network (VPLMN), wherein the request information is configured to request service information of a visited sensing application function; and
receiving the service information of the visited sensing application function sent by the core network device based on the request information, wherein the service information is at least configured to indicate an address of the visited sensing application function.

18. The method according to claim 17, wherein sending the request information to the core network device of the VPLMN comprises:
sending the request information to an access and mobility management function (AMF) of the core network device, wherein the request information is sent by the AMF to a session management function (SMF) of the core network device;
receiving the service information of the visited sensing application function sent by the core network device based on the request information comprises:
receiving the service information sent by the AMF, wherein the service information is sent by the SMF to the AMF.

19. The method according to claim 18, wherein,
sending the request information to the AMF of the core network device comprises:
sending a packet data unit (PDU) session establishment request message carrying the request information to the AMF;
receiving the service information sent by the AMF comprises:
receiving PDU session response information carrying the service information sent by the AMF, wherein the PDU session response information is associated with PDU session establishment accept.

20. (canceled)

21. The method according to claim 19, wherein receiving the PDU session response information carrying the service information sent by the AMF comprises:
receiving a non-access stratum (NAS) message sent by the access network device, wherein the NAS message carries the service information, and the NAS message is carried in an N2 PDU session request sent by the AMF to the access network device.

22. The method according to claim 17, further comprising:
sending a first registration request for registering the UE with the visited sensing application function to the visited sensing application function; wherein the first registration request is configured to trigger the visited sensing application function to send a second registration request to the home sensing application function of the UE to request to register the UE with the visited sensing application function, and the visited sensing application function determines whether to register the UE with the visited sensing application function based on a registration response of the home sensing application function in response to the second registration request.

23. The method according to claim 22, further comprising one:
receiving an allow registration response sent by the visited sensing application function to allow the UE to register with the visited sensing application function, wherein the allow registration response is sent by the visited sensing application function after receiving a first registration response sent by the home sensing application function indicating that the UE is allowed to register with the visited sensing application function; and
receiving a disallow registration response sent by the visited sensing application function to disallow the UE to register with the visited sensing application function, wherein the disallow registration response is sent by the visited sensing application function after receiving a first registration response sent by the home sensing application function indicating that the UE is not allowed to register with the visited sensing application function.

24. (canceled)

25. (canceled)

26. The method according to claim 22, further comprising:
receiving a first sensing request sent by the visited sensing application function to instruct the UE to perform sensing; and
sending sensing information obtained by the UE performing the sensing based on the first sensing request to the visited sensing application function.

27.-60. (canceled)

61. A communication device, device comprising:
a processor; and
a memory for storing executable instructions of the processor;
wherein the processor is configured to:
receive request information sent by a user equipment (UE), wherein the request information is configured to request service information of a visited sensing application function; and
send the service information of the visited sensing application function to the UE based on the request information, wherein the service information is at least configured to indicate an address of the visited sensing application function.

62. (canceled)

63. A communication device, comprising:
a processor; and
a memory for storing executable instructions of the processor;
wherein the processor is configured to perform the method according to claim 17.
